(19) United States
(12) Patent Application Publication
(10) Pub. No.: US 2014/0108277 A1
(43) Pub. Date: Apr. 17, 2014

(54) Method and System for Verifying Accredited Investor Status

(71) Applicant: DealFlow Media, Inc., Jericho, NY (US)

(72) Inventors: Steven Dresner, Locust Valley, NY (US); Steven Lord, Pleasantville, NY (US)

(73) Assignee: DealFlow Media, Inc., Jericho, NY (US)

(21) Appl. No.: 14/048,759

(22) Filed: Oct. 8, 2013

Related U.S. Application Data
(60) Provisional application No. 61/714,325, filed on Oct. 16, 2012.

(51) Int. Cl. G06Q 30/00

(52) U.S. Cl. CPC G06Q 30/018
USPC 705/317

(57) ABSTRACT

A web based computerized system and method for verifying accredited investor status, includes a server capable of receiving data related to an investor or prospective investor. The server has software configured to determine, using analytic algorithms, whether, from the data, an investor or prospective investor is a natural person, and if so whether the investor or prospective investor meets the income and/or asset value thresholds in order to qualify as an accredited investor. If the system determines that the investor or prospective investor is not a natural person, the software is further configured to determine whether the investor or prospective investor, based on the received data, is an entity that qualifies as an accredited investor by the nature of the investor or prospective investor.

### CROSS REFERENCE

This is a nonprovisional application of Provisional Application No. 61/714,325 filed on Oct. 16, 2012, the contents of which is incorporated by reference in its entirety.

### FIELD OF THE INVENTION

The present invention relates generally to the field of financing and in particular to the raising of capital for new businesses, or providing additional capital financing to existing businesses, through the sale of shares representing an ownership interest in the business, or other securities of the company that operates the business and verifying accredited status of potential investors. More specifically, the invention relates to a web based method and system for determining if a prospective investor for the purchase of such shares is an accredited investor, as that term is understood in the market.

### BACKGROUND OF THE INVENTION

A company operating a business can raise capital for its enterprise through the sale of securities, which include stocks, bonds, notes, debentures, or other documents that represent a share in the company or a debt owed by the company. When a company proceeds to issue the securities, it is called an offering.

There are two types of offerings: private and public. A private offering is made to a limited number of persons who are so well-informed about the affairs of the company that the company does not need to file a registration statement with the state or federal government. In contrast, a public offering is made to the public at large and is governed by federal and state regulations.

Until the 1930's the public offering of securities was subject to minimal regulation. Investors had no reliable way of knowing whether the information they received about a public offering was correct and complete. Because of the lack of regulation, fraudulent public offerings were common, leading to the sale of worthless stock.

The Securities Act of 1933 (the “ACT”) enacted after the Stock Market crash of 1929 and the resulting Great Depression, set in place rules and regulations for public offerings of securities in interstate commerce or through the mails. Before a public offering can be made, a company must file with the Securities and Exchange Commission (“SEC” or “Commission”) a registration statement, or find an exemption from the statutory registration requirements. The registration statement must contain financial and other data, including the price at which shares will be offered to the public, commissions paid to those who underwrite the security, and any options to purchase that have been issued.

In addition to requiring the filing of a registration statement, the Securities Act of 1933 makes it unlawful to mail or transmit in interstate commerce any security for the purpose of sale or delivery unless it is preceded or accompanied by a prospectus (a written statement of information about the public offering) that fully discloses all material facts regarding the investment, including the financial status of the enterprise. Material facts are those that are necessary to enable a purchaser to weigh the advantages and disadvantages of the investment. The balance sheet contained in the prospectus must accurately reflect the financial status of the issuing company and should include its assets and liabilities.

Unless a company files a registration statement that is then approved by the SEC, it cannot legally make the public offering. Registration of the securities does not imply that the SEC has approved the issue or that it has found the registration disclosures to be accurate. It does mean that persons filing false or incomplete information with the commission subject themselves to the risk of fine or imprisonment or both. Additionally, those persons connected with making a false or incomplete registration statement or prospectus may be liable for damages to purchasers of the securities.

Intrastate securities (those not publicly offered in interstate commerce) are governed by the laws of the state in which the stock is traded. State control of intrastate securities traffic does not conflict with federal regulation of interstate transactions. Most states have enacted blue sky laws, which regulate public offerings in a manner similar to federal securities legislation. These state laws get their name from their attempt to stop the sale of stock in fraudulent and speculative enterprises that have nothing to offer but blue sky. Many states require registration of securities before a public offering can be made. If the business seems likely to commit fraudulent acts involving prospective purchasers of its securities, state registration will be denied, and the public offering will not be allowed to go forward.

The ACT provides companies with a number of exemptions to registration. For some of the exemptions, such as rules 505 and 506 of Regulation D, a company may sell its securities to what are known as “accredited investors.” The securities laws of different countries define the term accredited investor differently, but generally it is a term used to delineate investors who are sufficiently sophisticated in matters of business and finance to better understand the risks of an investment and thus are permitted to invest in certain types of higher risk investments including seed money, limited partnerships, hedge funds, private placements, and angel investor networks. The term generally includes wealthy individuals and organizations such as banks, insurance companies, significant charities, some corporations, endowments, and retirement plans.

In the United States, the federal securities laws define the term “accredited investor” in SEC's Rule 501 of Regulation D as:

a bank, insurance company, registered investment company, business development company, or small business investment company;

an employee benefit plan, within the meaning of the Employee Retirement Income Security Act, if a bank, insurance company, or registered investment adviser makes the investment decisions, or if the plan has total assets in excess of $5 million;

a charitable organization, corporation, or partnership with assets exceeding $5 million;

a director, executive officer, or general partner of the company selling the securities;

a business in which all the equity owners are accredited investors;

a natural person who has individual net worth, or joint net worth with the person's spouse, that exceeds $1 million at the time of the purchase, excluding the value of the primary residence of such person;

a natural person with income exceeding $200,000 in each of the two most recent years or joint income with a spouse exceeding $300,000 for those years and a reasonable expectation of the same income level in the current year; or

a trust with assets in excess of $5 million, not formed to acquire the securities offered, whose purchases a sophisticated person makes.

Therefore, in the United States, for a person to be considered an accredited investor, he, she or it must either meet the requirements of one of the defined categories, or if a natural person, must have a net worth of at least one million US dollars, not including the value of one's primary residence or have income of at least $200,000 each year for the last two years (or $300,000 together with his or her spouse if married) and have the expectation to make the same amount this year. Net worth includes the value of non-primary houses and automobiles. Thus, many homeowners are accredited investors due to the value of their real estate. The $1 million net worth and $200,000 income standards were established in 1982 and have not increased with inflation.

The SEC has considered a change to the definition of “accredited investor” to create a new class of potential investors: “accredited natural persons”. The proposed changes would stipulate that an “accredited natural person” must be both “accredited investors” under the existing standards and also own not less than $2.5 million in investments (as currently defined in the Investment Company Act for purposes of the Section 3(c)(7) exemption) on the date an investment is made. The $2.5 million test will be periodically adjusted for inflation.

The following types of entities (referred to herein as “accredited entities”) are accredited investors: a bank, insurance company, registered investment company, business development company, or small business investment company; an employee benefit plan, within the meaning of the Employee Retirement Income Security Act, if a bank, insurance company, or registered investment adviser makes the investment decisions, or if the plan has total assets in excess of $5 million; a charitable organization, corporation, or partnership with assets exceeding $5 million; a business in which all the equity owners are accredited investors; or a trust with assets in excess of $5 million, not formed to acquire the securities offered, whose purchases a sophisticated person makes.

On Jan. 25, 2011, the Securities and Exchange Commission (SEC) voted to propose certain amendments to the net worth standard for determining accredited investor status under the rules promulgated by the Securities Act of 1933. These amendments reflect the requirements of Section 413(a) of the Dodd-Frank Wall Street Reform and Consumer Protection Act (Dodd-Frank Act). Although Section 413 was effective on Jul. 21, 2010, upon enactment by operation of the Dodd-Frank Act, the SEC is still required to revise the Securities Act rules to reflect the new standard. In addition, the SEC is proposing technical amendments to Form D and a number of rules to conform them to the language of Section 413(a) and to correct cross-references to former Section 4(6) of the Securities Act, which was renumbered Section 4(5) by the Dodd-Frank Act. Under proposed Securities Act of 1933 Rules 215 and 501, the value of a person's primary residence would be excluded for purposes of determining whether the person qualifies as an “accredited investor” on the basis of having a net worth in excess of $1 million. Previously, the net worth standards required a minimum net worth of more than $1,000,000, but permitted the primary residence to be included in calculating net worth.

The proposed amendments would define an accredited investor, among other things, as: “Any natural person whose individual net worth, or joint net worth with that person's spouse, at the time of purchase, exceeds $1,000,000, excluding the value of the primary residence of such natural person, calculated by subtracting from the estimated fair market value of the property the amount of debt secured by the property, up to the estimated fair market value of the property.”

Neither the ACT itself nor the ACT's rules define the term “net worth,” so the proposing release states that the purpose of adding the phrase introduced by the words “calculated by” is to clarify that net worth is calculated by excluding only the investor's net equity in the primary residence. The SEC believes this approach is consistent with and advances the regulatory purposes of Section 413(a) because it reduces the net worth measure by the amount or “value” that the primary residence contributed to the investor's net worth before enactment of Section 413(a). The SEC also notes that some of its existing rules are similar in approach to the proposed rules. For example, Rule 701 under Regulation R provides for the exclusion of the value of a person's primary residence in applying a net worth standard and also provides for the exclusion of “associated liabilities,” such as mortgages.

The proposed rules do not define “primary residence,” although they provide that issuers and investors should be able to use the commonly understood meaning of the term—the home where a person lives most of the time. Section 413(b) of the Dodd-Frank Act specifically authorizes the SEC to undertake a review of the definition of the term “accredited investor” as it applies to natural persons, and requires the SEC to undertake a review of the definition “in its entirety” every four years, beginning in 2014.

Among other things, the changes required by Section 413 of the Dodd-Frank Act impact the legal requirements governing unregistered offers and sales of securities, i.e., “private placement” exemptions from the registration requirements of the ACT relied on by companies in raising private capital from individuals. One of the requirements of certain private placement exemptions is for capital to be raised from accredited investors. By excluding the value of an investor's primary residence in calculating net worth, indebtedness secured by the primary residence would be netted against the value of the primary residence up to the fair market value of the property. This may cause fewer individuals to qualify as accredited investors, thereby reducing available private capital.

It should be apparent from the foregoing that determining whether or not a person qualifies as an “accredited investor” may not be so easy, particularly since the legal definition of the term tends to change from time to time.

The situation is further complicated by the enactment in the United States of the Jumpstart Our Business Startups Act (the “JOBS Act”). Under this legislation, the United States Congress has mandated the SEC to relax the requirements of the Securities Act of 1933 relating to general solicitation for the sale of a company's securities.

In response, the SEC has issued proposed rules to accomplish the purposes of the JOBS Act. In doing so, the SEC has stated: “We are adopting amendments to Rule 506 of Regulation D and Rule 144A under the Securities Act of 1933 to implement Section 201(a) of the Jumpstart Our Business Startups Act. The amendment to Rule 506 permits an issuer to engage in general solicitation or general advertising in offering and selling securities pursuant to Rule 506, provided that all purchasers of the securities are accredited investors and the issuer takes reasonable steps to verify that such purchasers are accredited investors. The amendment to Rule 506 also includes a non-exclusive list of methods that issuers may use to satisfy the verification requirement for purchasers who are natural persons. The amendment to Rule 144A provides that securities may be offered pursuant to Rule 144A to persons other than qualified institutional buyers, provided that the securities are sold only to persons that the seller and any person acting on behalf of the seller reasonably believe are qualified institutional buyers. We are also revising Form D to require issuers to indicate whether they are relying on the provision that permits general solicitation or general advertising in a Rule 506 offering.” (see SEC Release No. 33-9415; No. 34-69959; No. IA-3624; File No. S7-07-12

As a result of implementing SEC's new rules, issuers will need to “to take reasonable steps to verify that purchasers of the securities are accredited investors,” The purpose of the verification mandate is to address concerns, and reduce the risk, that the use of general solicitation under Rule 506 may result in sales to investors who are not, in fact, accredited investors. Because it is anticipated that the implementation of the JOBS Act will result in many issuers using the internet and social media platforms for offerings and solicitations for the sale of its securities under the relaxed requirements of Rule 506, there is a greater need to insure that investors are sufficiently sophisticated to be able to appreciate the offerings being made and to understand the need for due diligence so that fraudulent situations can be avoided or minimized.

In order for an issuer to “take reasonable steps to verify” that the purchasers of the offered securities are accredited investors, issuers would need to consider a number of factors, including: the nature of the purchaser and the type of accredited investor that the purchaser claims to be; the amount and type of information that the issuer has about the purchaser; and the nature of the offering, such as the manner in which the purchaser was solicited to participate in the offering, and the terms of the offering, such as a minimum investment amount. Of course, some purchasers may be accredited investors based merely on their status, such as a broker dealer, or an investment company. Natural persons, however, must meet the required financial thresholds. Accordingly, the steps that an issuer uses to determine if a purchaser is an accredited investor based on that purchaser's status may be reasonable, but the same steps may not be reasonable when determining if a natural person is an accredited investor. The amount and type of information that an issuer has about a purchaser would be a significant factor in determining what additional steps would be reasonable to verify the purchaser's accredited investor status. The more information an issuer has indicating that a prospective purchaser is an accredited investor, the fewer steps it would have to take, and vice versa. The SEC has also been urged to allow issuers to rely on third party firms to verify accredited investor status, particularly where the third party is not involved in the offering. Failure of issuers to ensure accredited status of its investors may result in penalties or other sanctions.

Accordingly, there exists a need to provide systems and methods for facilitating an issuer's requirement to satisfy the verification mandate.

### SUMMARY OF THE INVENTION

The present invention therefore provides a web based system and method by which an issuer seeking to raise capital under the relaxed requirements of the JOBS Act may meet its obligations without the need to undertake extensive and time consuming due diligence. Such issuer (or an agent working on the issuer's behalf) will simply access the system maintained by a third party through the Internet. Such system includes computer operated software for analyzing data related to the purchaser and calculating pass-no-pass thresholds at various gates so that a reasonable conclusion may be reached. At each step of the process of verification, the software analyzes the available data based on input by a user (which can be provided over the Internet) and, if necessary, determines the next appropriate evaluation.

More specifically, the invention provides a computerized system and method for verifying accredited investor status, which includes a server capable of receiving data related to an investor or prospective investor. The server has software configured to determine, using analytic algorithms and based on information provided to or obtained by the server, whether an investor or prospective investor is a natural person, and if so whether the investor or prospective investor meets the income and/or asset value thresholds in order to qualify as an accredited investor. If, based on information provided to or obtained by the server, the software determines that the investor or prospective investor is not a natural person, the software is further configured to determine whether the investor or prospective investor is an entity that qualifies as an accredited investor by the nature of the investor or prospective investor. The invention further provides for storing accredited investor status in a database for future reference and access by interested users of the system.

### BRIEF DESCRIPTION OF THE DRAWINGS

An example of the invention is illustrated in the annexed drawings in which:

FIG. 1 is a flow chart and overview illustrating the system and process of the invention;

FIG. 2 is a flow chart illustrating process overview;

FIG. 3 illustrates process logic determining whether an investor is a “natural person” and therefore subject to further verification;

FIG. 4 illustrates steps of the system for verification of an investor based on income;

FIG. 5 illustrates steps of the system for verification of an investor based on assets;

FIG. 6 illustrates steps of the system for determination of the nature of the offering and the manner of solicitation, which in turn determine the intensity of accredited status verification;

FIG. 7 is a flow chart illustrating initial processing and screening of an investor applicant;

FIG. 8 illustrates initial cataloguing of investor prospects, whether verification is necessary, and to what degree;

FIG. 9 illustrates the ageing process used to determine whether previous accredited verifications are valid;

FIG. 10 illustrates weighted verification scoring system using cloud-based data sources;

FIG. 11 illustrates weighted verification scoring system using direct characteristics/attributes; and

FIG. 12 illustrates weighting verification scoring system for processing uploaded investor documentation necessary for verification.

### DESCRIPTION OF THE INVENTION EMBODIMENTS

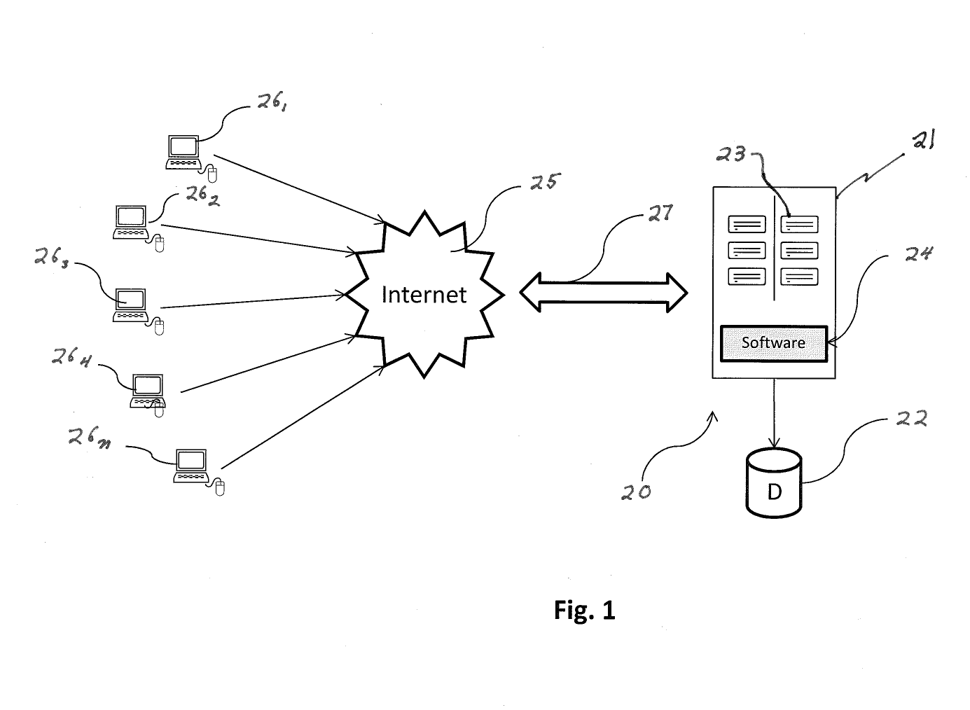

Referring now to the annexed drawings, FIG. 1 illustrates the overall web based Internet architecture of the system of the invention for verifying accredited investor status. The system 20 includes a server 21 and a database 22. The server includes control elements 23 and software 24 including algorithms configured to analyze data and other information received by the system for carrying out the steps of the invention as further described herein. The server is connected through operating communication links 27 for two-way communication with the Internet 25. Users, such as persons interested in investing in certain businesses opportunities, a “deal”, which may be available for viewing through a user interface of the system, or persons sponsoring a deal (an “issuer”), processors 26₁-26ₙ which are capable of interacting with the Internet, may therefore communicate with the system server 21.

As noted above, an investor or potential investor may be classified as an accredited investor based solely on the nature of such investor or potential investor. For example, banks, insurance companies, broker-dealers, natural persons with minimum amounts of net worth and/or income, and certain trusts are accredited investors merely by the nature of their character. Accordingly, data about an investor or potential investor is fed to the server 21 where algorithms analyze and characterize the data for scoring, as described herein, to determine if indeed such investor is verified as an accredited investor.

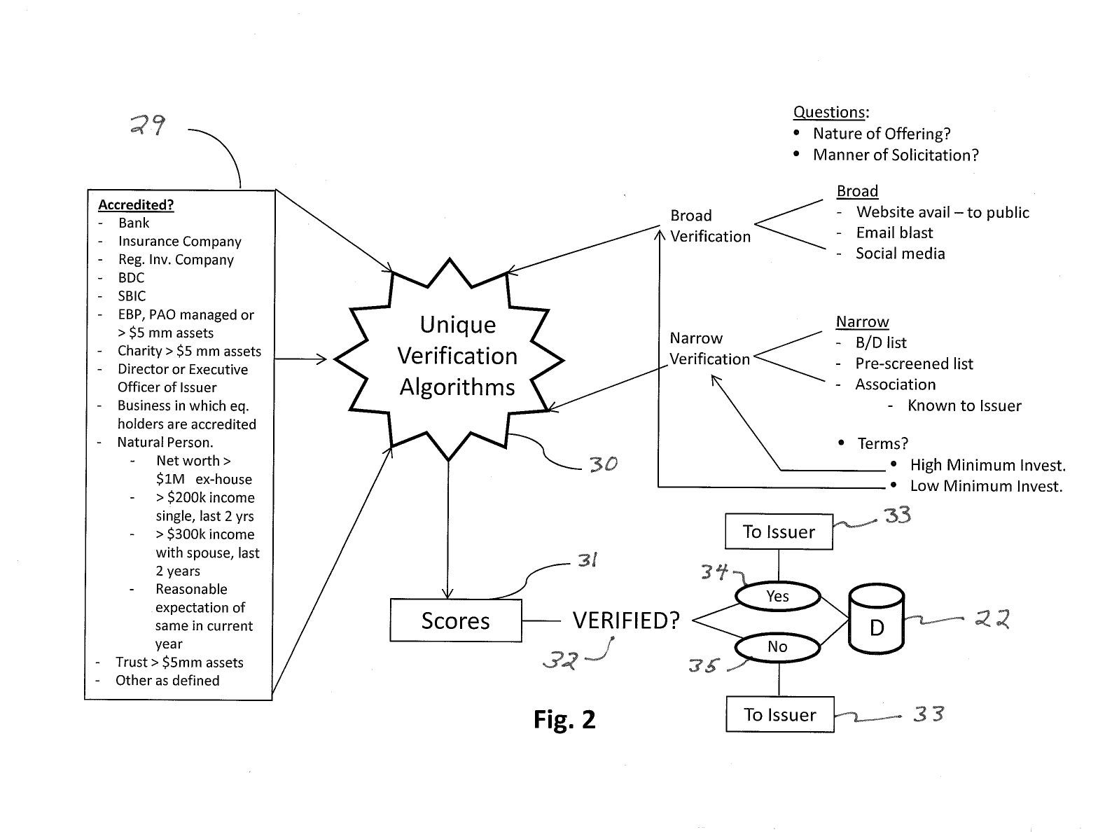

The nature of an offering for raising financing may also determine status of accreditation. Accordingly, the system's verification algorithms 30 (see FIG. 2) may receive a request for verification of investor status from a variety of investors 29 and will issue queries either in a broad manner such as through the Internet to the public generally, through a targeted email blast or through social media to gather the necessary data to determine status. A more specific or narrow query may be sent by the system directly to a broker-dealer list, a pre-screened list of data sources, or to associations known and trusted by an issuer. The information retrieved from the broad or narrow queries is fed to algorithms 30 for analysis. After analysis of the received data, algorithms 30 establish scores for assessing status. Once the scores 31 have been determined by the verification algorithms 30 and a verification step 32 confirms status one way or the other, such information, either a “yes” 34 or “no” 35 accredited status, may be feed directly to the issuer 33 (such as through the Internet) and/or retained in the database 22 for future reference. The information stored in the database can therefore be used to identify accredited investors for potential deals, statistical analysis, to establish networks and to determine the history of certain investors.

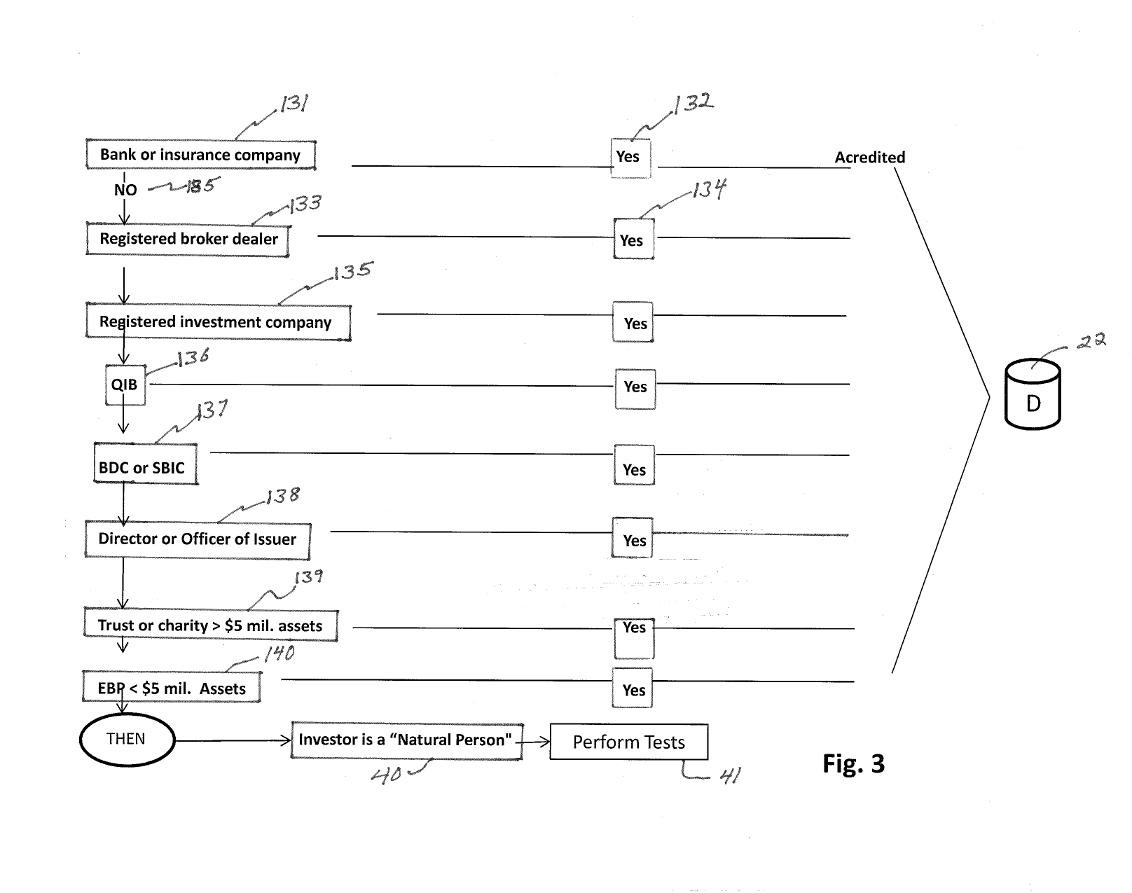

As illustrated in FIG. 3, the system determines the nature of an investor, leading to either further tests being performed or storage of accredited status in database 22.

Based on input fed to the server by a source knowledgeable about the investor, or input acquired by the server in response to inquiries sent out from the server to sources knowledgeable about the investor, the analytic capabilities of the software algorithms determine first the nature of the potential investor. For example, if a potential investor is a bank or insurance company 131, then by definition such investor is accredited. A signal 132 indicating “yes” will then determine the accreditation and be stored in the database 22. If, at 185, the potential investor is not a bank or an insurance company, the next query is whether it is a registered broker-dealer 133. If the analysis indicates it is a registered broker-dealer, then a “yes” signal 134 will indicate accredited status which will be stored. If not, then the query is whether or not it is a registered investment company 135. Similarly, if “yes”, such information is stored, and if no, then the software inquires of the data whether it is a qualified institutional buyer (“QIB”) 136 or a known sophisticated buyer of securities. If yes, it is stored, if no, the inquiry is whether or not the investor is a business development corporation (“BDC”) or small business investment company (“SBIC”) 137. These inquiries then continue through the other categories that qualify an investor as accredited based on the nature of the investor. These include directors or officers of the issuer 138, a trust or charity with more than $5 million dollars in assets 139, etc. If none of these categories are determined and rather the analysis determines that the investor is a natural person 40, algorithms in the software of the server are then employed to perform certain tests 41 in order to determine if the natural person is an accredited investor.

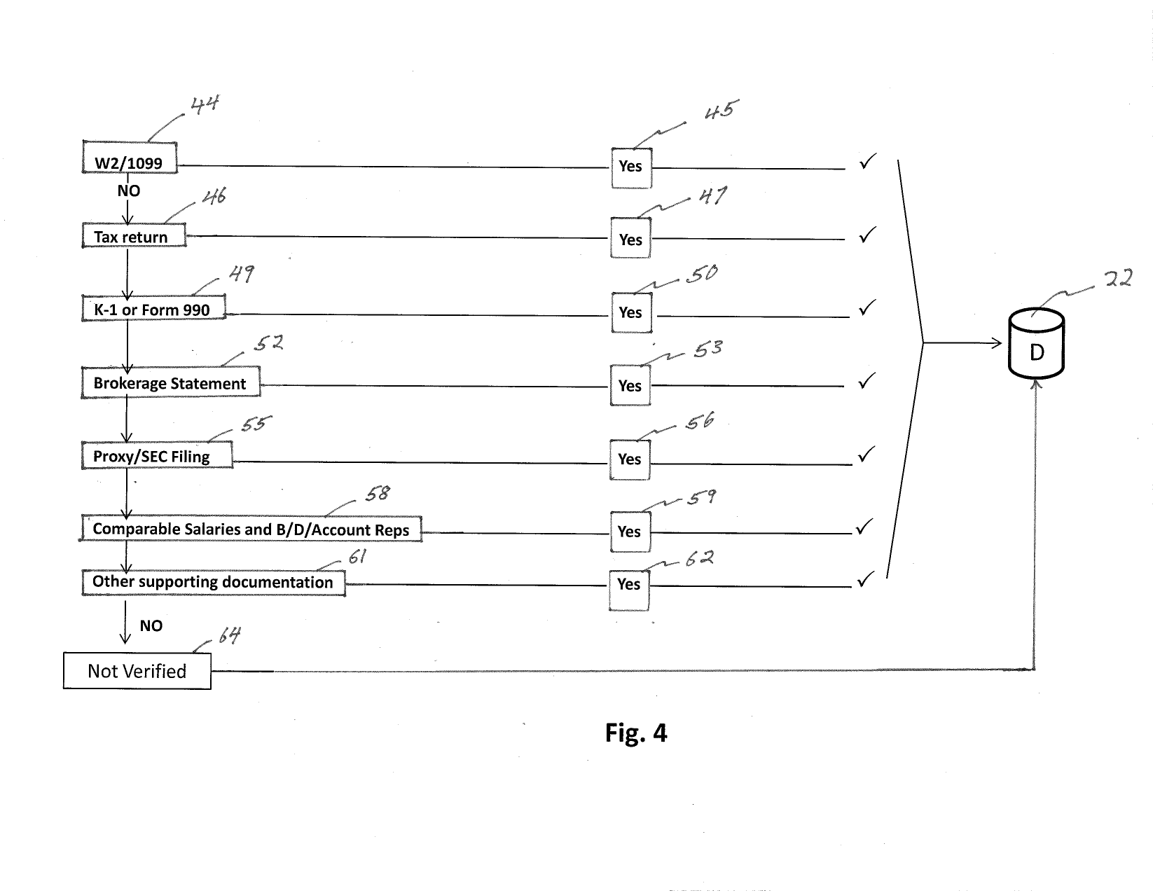

The steps for verifying accredited investor status of a natural person using income as the determinative factor is illustrated in FIG. 4.

As indicated above, certain levels of income will qualify a natural person as an accredited investor. Accordingly, data using documentation and other sources is provided to the server to be analyzed by the software algorithms resulting in a scoring.

Depending on the amount to be invested or subscribed for (“subscription amount”), accredited investor status can be established merely by knowing the subscription amount itself. For example, when an investor subscribes for an offering of securities having a value in excess of $1,000,000, by definition this investor is accredited, since the amount of the investment exceeds the net worth threshold.

So for example, a person's W-2 or 1099 Statements 44 may be sufficient to qualify a person as an accredited investor. Such information is provided to the server for analysis by the software. A scoring analysis conducted by the software of the system will determine this. If “yes”, signal 45 is then fed to the database 22. Similarly, a person's tax return 46 may qualify a person. Again the qualified status will be stored in the database. If not, IRS Form K-1 or Form 990, 49, having been provided to the server, will be analyzed and scored. A yes or no indication is then established. Data from brokerage statements 52, proxy and SEC filings 55, comparable salaries and broker-dealer accounts 58 or other supporting documentation 61 will also be analyzed and yes/no determinations made. If none of these analyses establish an accredited investor status, then no such indication is stored in the data base, and rather a “not verified” indication 64 is stored.

If on the other hand, the subscription amount is low (under the threshold for net worth or income), then tests 41 may be repeated and any of the data contained in 44, 46, 49, 52 or 55 can be analyzed to determine status.

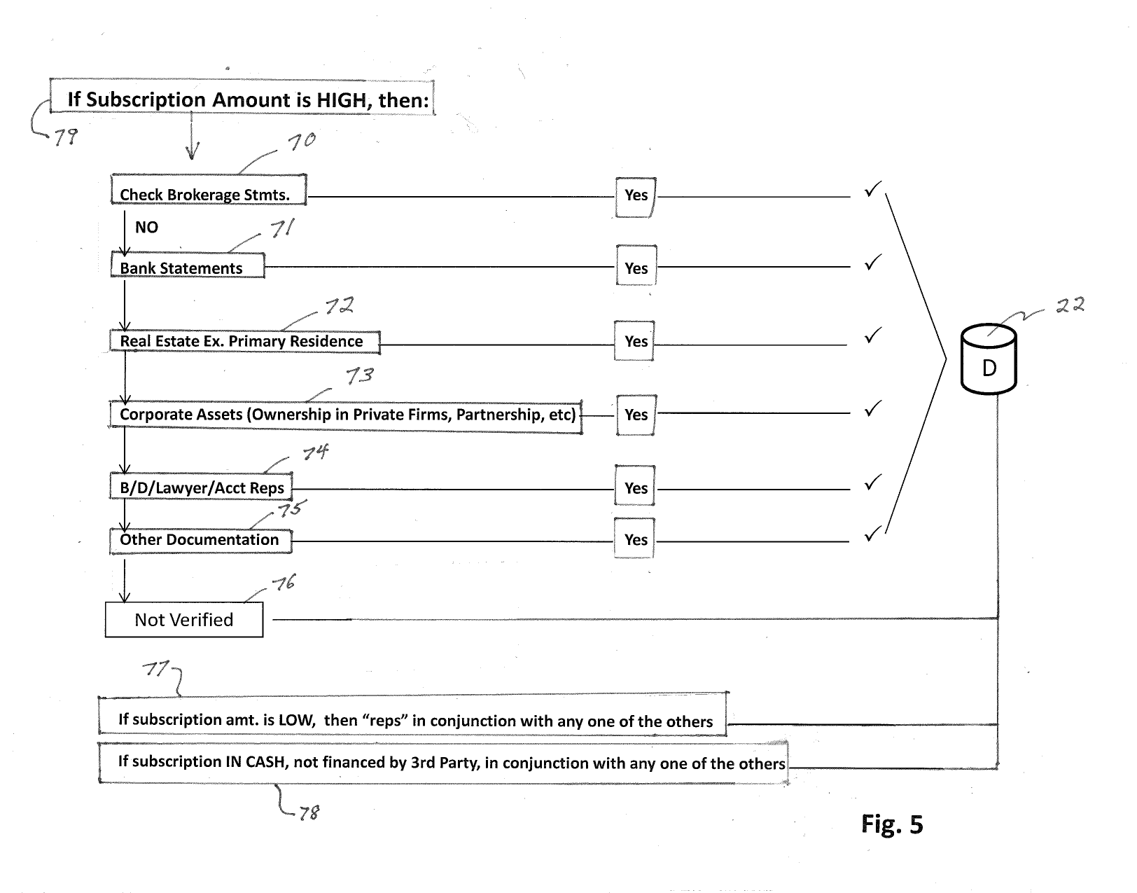

Also as noted above, accredited status may be determined by the asset level of a natural person. Accordingly, to check such asset level and analyze whether the data relating to a person's asset level qualifies him or her as an accredited investor, such data is again provided to the system, analyzed by the algorithms, and yes/no determinations are made. FIG. 5 illustrates this process for both “high” and “low” asset levels. For high subscription amounts, 79, such data comes from checking and brokerage statements 70, bank statements 71, value of real estate 72 excluding primary residence, assets relating to corporate ownership 73, broker-dealer, lawyer and accountant representations 74, and other documentation 75 which bears on a person's asset value. These will be analyzed by the system. If any of the data related to these documents or other information qualifies a person as an accredited investor, such indication will be stored in the data base 22. If not, the not verified indication 76 will be stored. When the asset levels are low relative to the subscription amounts, then additional representations together with any of the forgoing documentations may be made at 77. Subscriptions in cash, 78, can also be analyzed in conjunction with the foregoing other documentation.

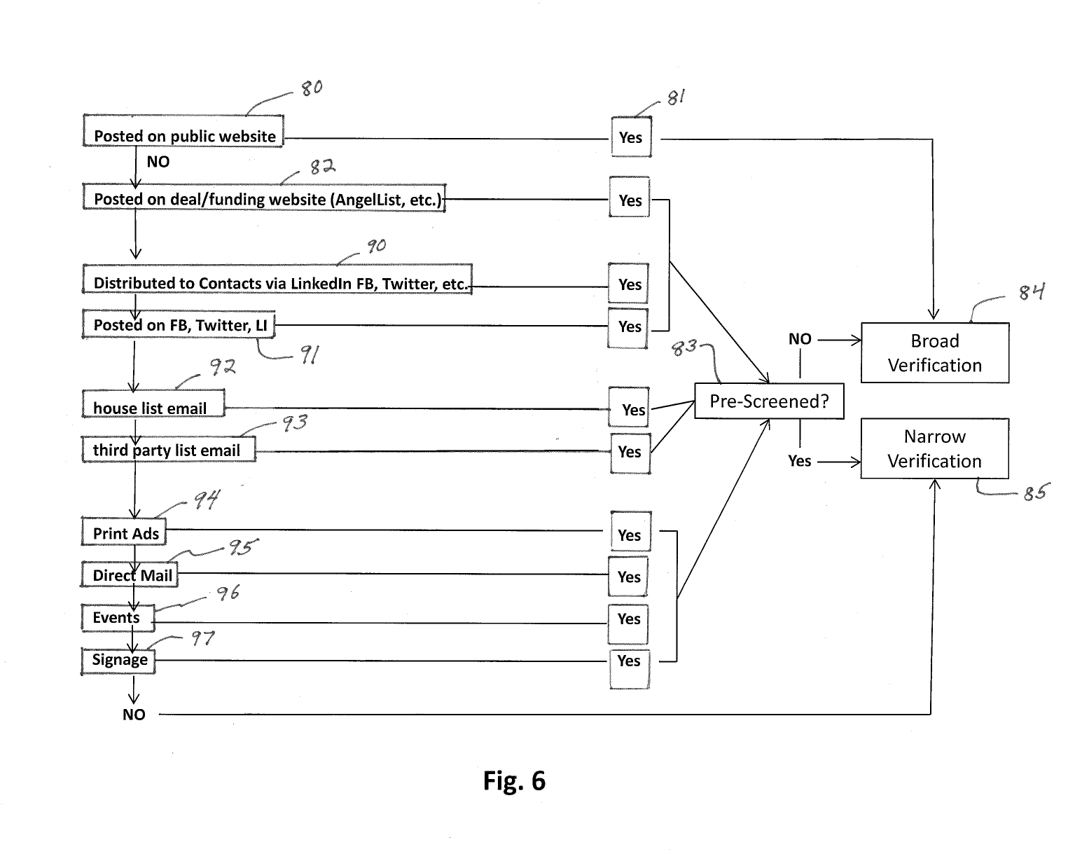

FIG. 6 illustrates the process of determining accredited status by analyzing the nature of the offering, specifically where the offering has been advertised and/or how the potential investor has come into contact with the offering. The results of this analysis determine the intensity of the verification tests to be performed by the system software.

For example, a deal listing 80 on a public website would require a person has previously been qualified as an accredited investor or can be fed to the system for analysis and subsequent broad verification (described below). Analysis of deal information posted on a deal funding website such as AngelList can also be supplied to the system at 82 for analysis, verification and subsequent indication of accredited investor status. If the deal information regarding an offering was advertised to a house list belonging to a registered broker-dealer or a third-party list consisting of pre-screened accredited investors, such status may still be questionable and the system software is configured to establish whether that determination and accredited status had been pre-screened at 83. If not, broad verification at 84 is required and if yes, only narrow verification at 85 is required. Similar steps are carried out with respect to deals that are offered or advertised on social media websites, such as LinkedIn, Facebook, Twitter, etc. at steps 90, 91, email solicitations 92, 93, or traditional awareness methods including print ads 94, direct mail 95, events 96 or signage (97).

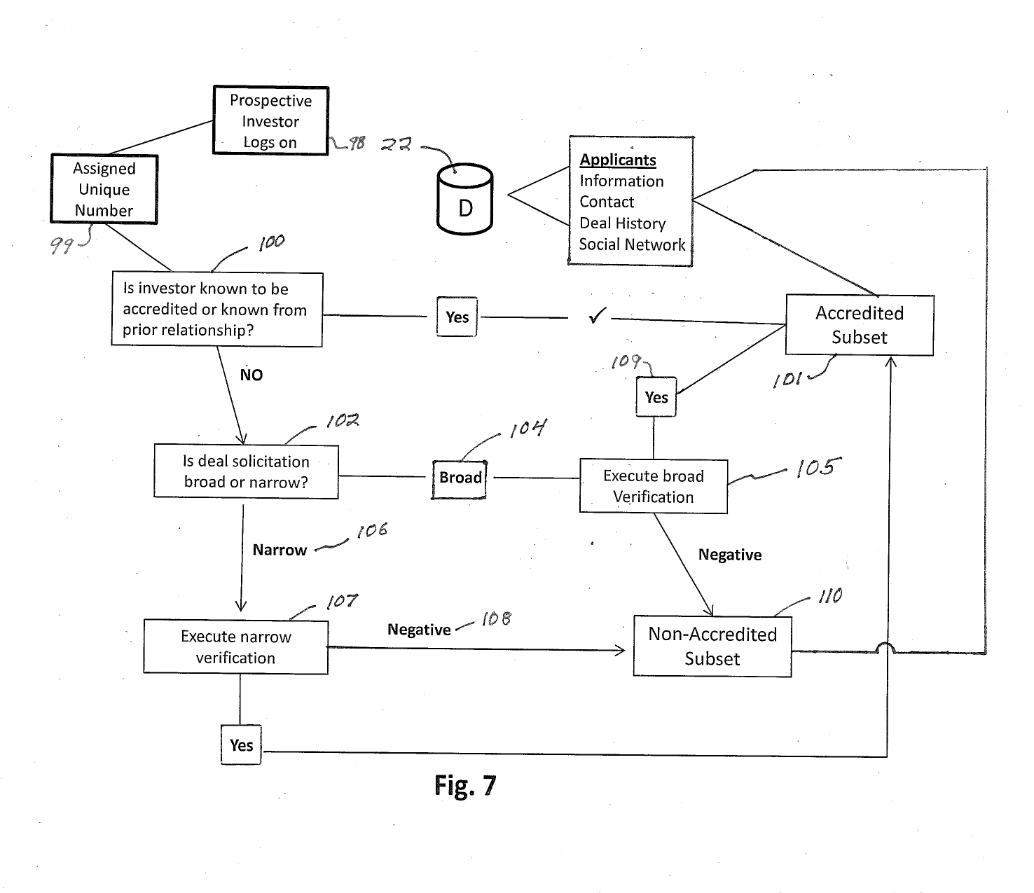

The process for initially screening or cataloging perspective investors and whether or not verification is required, and to what degree, is generally illustrated in FIG. 7. The first step is for the prospective investor to log on at 98 and the system will assign that investor a unique identifying number. Then the system at 100 determines whether the prospective investor is known to be accredited from history of prior relationship with the issuer making the offering, a broker-dealer, or other third-party. If yes, the system will initiate an accredited subset verification process 101 through an algorithm of the software. If no, the system initiates a query as to whether or not the solicitation for investment is broad or narrow at 102. If a “broad” determination is made by the system at 104, initiation at 105 of broad verification is undertaken. If that is positive at 109, then the accredited subset is established.

If on the other hand the solicitation is narrow at 106, narrow verification at 107 is undertaken. If either that determination or the determination of the broad verification 105 is negative, then a nonaccredited subset verification process 110 is initiated. If the narrow verification process 107 is positive, then the accredited subset verification process 101 is initiated.

The information from either the accredited or non-accredited subset processes is then stored in database 22.

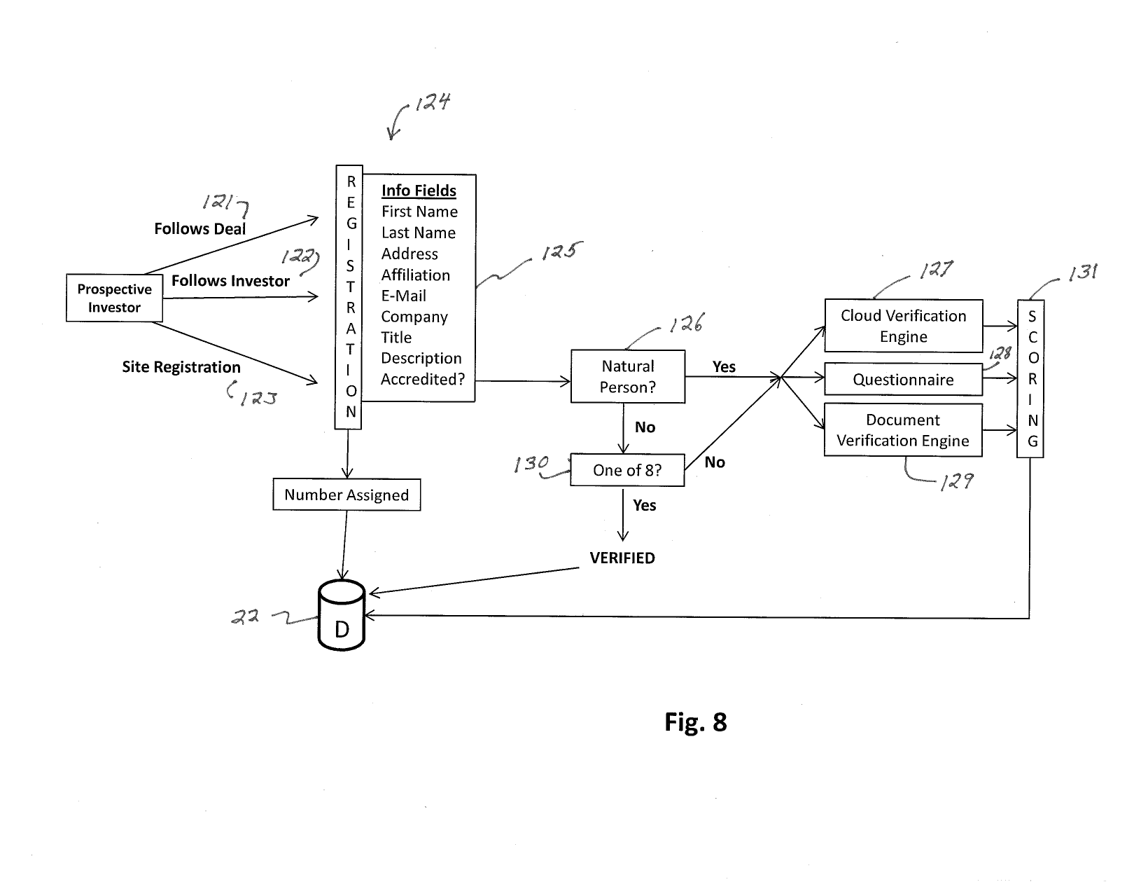

The system and method of the present invention further provides for registration of prospective investors and storage of accredited investor status in FIG. 8.

The verification algorithms execute and deliver a weighted verification score (“WVS”) to be stored with the investor's database record.

There are three channels through which a prospective investor 120 may initiate registration. A first channel is by following a deal 121, or by following a particular investor at 122 or through site registration 123. Each of these channels will initiate the registration process 124. The registration process requires populating the fields at 125. A prospective investor 120 will directly or indirectly, provide information through an interface of the system for determining status, including whether they have been previously accredited through one of these channels. A unique classification number is assigned to that investor's registration. Regardless of whether or not the prospective investor has an accredited status, registration information about the prospective investor will be captured by the system and stored in the database 22. If the investor indicates that he or she is accredited during information input to the system, the verification process will begin.

If the populated fields 125 indicate at 126 that the prospective investor is a natural person, then there are three verification algorithms that will be employed. The cloud verification engine 127, the questionnaire 128 and the document verification engine 129 will be initiated to establish a scoring 131 for this prospective investor which is then input to the database 22.

If the information input at 125 indicates that the prospective investor is not a natural person, then the system determines at 130 whether the status of the investor meets one of the eight categories to be an accredited investor. If this investor qualifies, then the accredited investor status is deemed verified and stored in database 22. If not, the verification process for scoring through the cloud verification engine 127, the questionnaire at 128 and the document verification engine at 129 is initiated to establish a scoring.

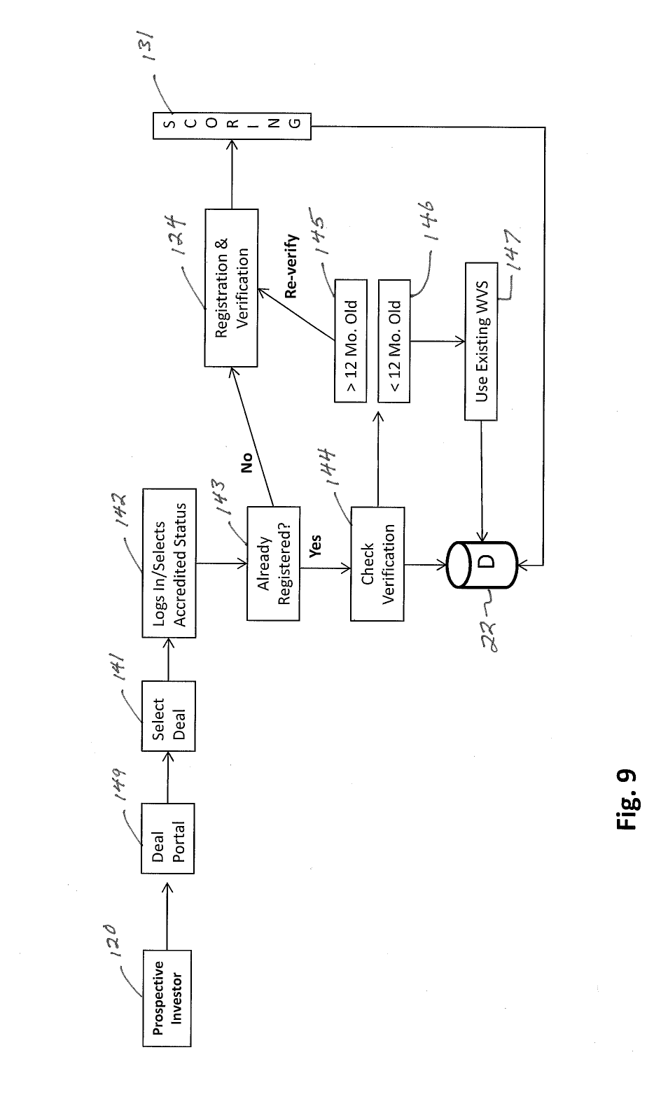

As discussed above, there are numerous situations where a prospective investor had been previously determined to be accredited. Whether or not that investor still qualifies for such status should be determined. The process for doing so is illustrated at FIG. 9. Here, as an example of how the prospective investor comes into contact with an offering related to a deal, the prospective investor 120 will access the system through deal portal 149 and look for deals in which the investor might be interested. The investor will select a deal of interest at 141, and then log in to the deal portal 149 and be prompted to select the “accredited status” inquiry at 142. The system will determine at 143 by checking the database to verify whether or not the investor is established as a prior verified accredited investor. If not, the investor will then be prompted to register and go through the verification and scoring process described above. The scoring 131 is then input to database 22.

If the database indicates that this prospective investor has previously been verified as an accredited investor, the system will at 144 check the database and determine whether or not the verification is older than twelve months. If it is older than 12 months, then the system at 145 will initiate the registration and scoring process 124 again. If the prior verification was less than twelve months old, then the system will determine at 147 that no new verification is required and will re-establish the prior verification and record in database 22.

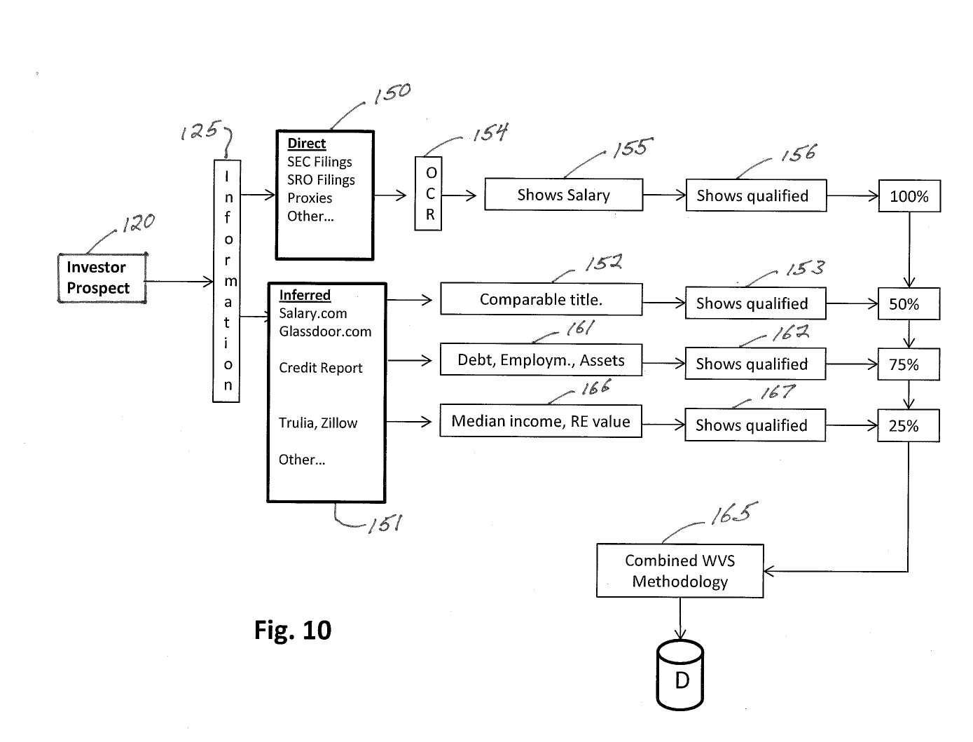

Verification is processed through a weighted scoring system utilizing three independent tiers of information, illustrated in FIGS. 10, 11 and 12. The cloud-based scoring system utilizes publically available information from which accredited status can be directly or indirectly inferred, such as SEC filings of public corporations, credit reports, comparable real estate transactions, etc., using optical character recognition (OCR) 154 as necessary.

Depending on the nature of the information obtained, the system assigns a weighting to the information to be stored in combination 165 with all other verification data points. Some cloud-based information may be sufficient for verification, such as salary information gleaned from SEC filings 150 155. If the information and attendant weighting assigned is sufficient for verification 156, the investor is considered accredited and the database 165 is updated accordingly.

The inferred searches 151 can support accredited verification by third party corroboration or association. For example, the inferred searches relating to salary or a particular investor's company will yield information, 152, relating to comparable titles and businesses for other similarly situated accredited investors. This suggests, 153, qualification as an accredited investor, but it will only be verified to a certain degree. The drawings illustrate only examples of such degree.

A third party search through credit reports will yield at 161 information relating to debts, employment and assets, and will, at 162, determine the extent of qualification. Again, only a certain degree of verification can be expected. An example is illustrated. Median income data, and real estate values 166 will also suggest qualification at 167.

Each result is scored by the system on a percentage basis required for verification as exemplified in the drawings. The results of the percentage basis are combined at 165 and the weighted verification score is then stored in the database 22.

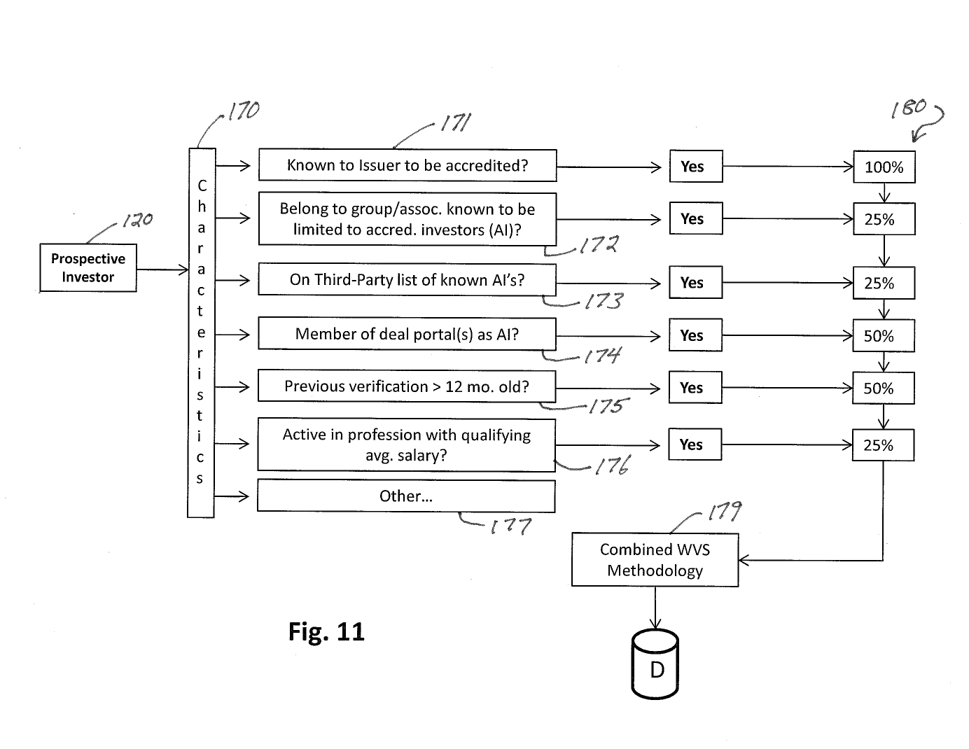

A prospective investor 120 has various personal characteristics that may assist in verification. Accordingly, the system of the invention queries inside and outside sources to determine which characteristics assist in the verification process. Such queries may be initiated as emails sent from the server to a particular source or to many sources. Each result is scored by the system on a percentage basis as required for verification and the results are included in a combined weighted verification score which are then stored in the database. This process is illustrated at FIG. 11 where the prospective investor 120 inputs at 170 various characteristics. Such characteristics include whether or not this prospective investor is known to the issuer to be accredited 171, whether this prospective investor belongs to a group or association known to be limited to accredited investors at 172, at 173 information as to whether or not the prospective investor is on a third-party list of known accredited investors, and step 174 will indicate whether the prospective investor is a member of deal portals. Such characteristics also include whether or not the investor had been previously verified to be an accredited investor, and if so, whether that verification is more than twelve months old at 175, and whether the prospective investor is active in a profession with qualifying average salaries. Other similar characteristics at 177 may also be provided for analysis by the system. The result of each of these characteristics is scored by the system at 180 and the combined weighted verification score is calculated by the system at 179 and input to the database 22.

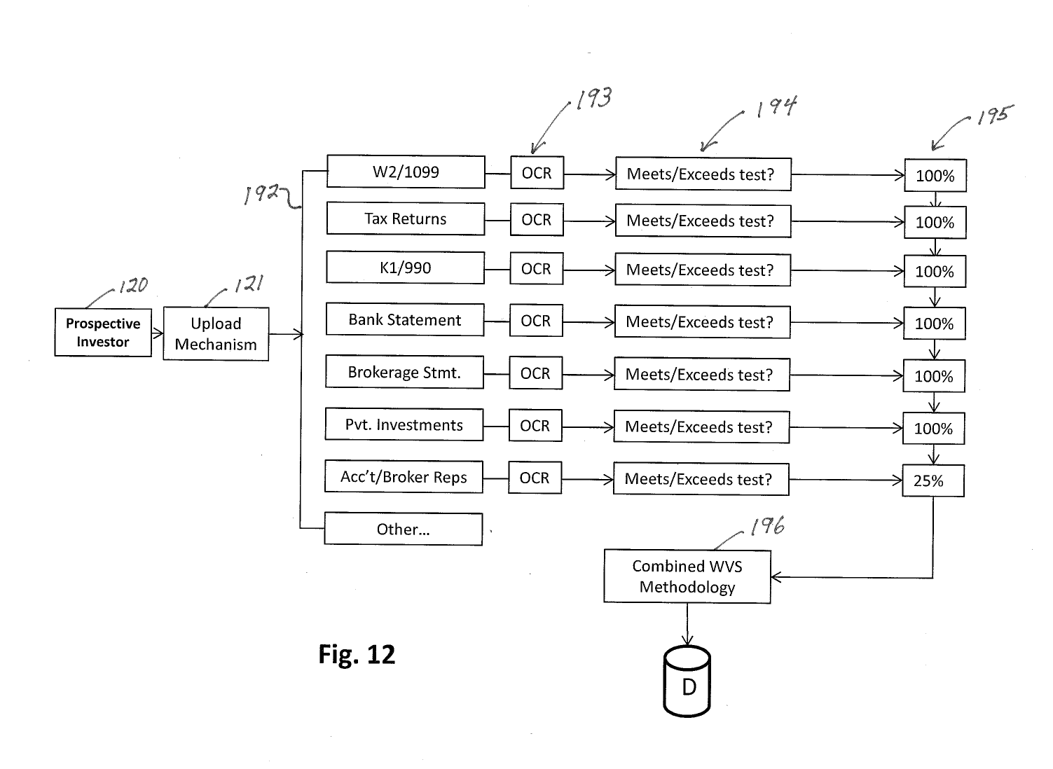

As noted above, a third weighted scoring system in FIG. 12 involves investors wishing to be verified uploading certain documents, data or other information containing direct support for accredited status. The system will use its OCR capability 193 to recognize relevant terminology, data and other information. Each data point derived is compared against the tests for income and assets, and a determination is made whether it meets, exceeds or fails the requirements for accreditation. Each result is scored by the system on a percentage basis as required by verification and the results are written into the database. Examples of such documentation is illustrated in FIG. 12.

Here, the prospective investor 120 will upload at step 121 the various documents in support of accredited verification as identified at 192. The optical character recognition 193 will recognize the relevant terminology and data so that the system will determine at 194 whether or not the information provides sufficient support for meeting or exceeding the accredited verification status. Each result is scored at 195 and the combined weighted verification scoring 196 is input into the database 122.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A computerized method for verifying accredited investor status, comprising:
receiving at a server data related to an investor or prospective investor;
determining by analytic algorithms housed on said server and based on said data whether said investor or prospective investor is a natural person;
determining by analytic algorithms housed on said server and based on said data whether said investor meets income and/or asset value thresholds in order to qualify as an accredited investor if said investor is a natural person; and
determining by algorithms housed on said server and based on said data whether said investor is an entity that qualifies as an accredited investor by the nature of the investor.

2. The method according to claim 1 wherein said method is web based and wherein said step of receiving data at said server is a result of communication with said server over the Internet from a client user over a communication link.

3. The method according to claim 1, further comprising storing accredited investor status in a database.

4. The method according to claim 1, further comprising scoring said data for determining investor status.

5. The method according to claim 4, wherein said scoring uses a weighted verification score.

6. The method according to claim 2 wherein said algorithms are configured for initiating verification inquiries through said communication link on a broad or narrow basis.

7. The method according to claim 6 where in responses to said inquiries are received by said server for analysis by said algorithms and verification of investor accredited status.

8. The method according to claim 7 wherein said verification is stored in said database.

9. The method according to claim 8 further comprising providing access to said data base by client users for viewing through and interface the accredited status of an investor or potential investor.

10. The method according to claim 1 wherein said determining whether said investor is an entity that qualifies as an accredited investor by the nature of the investor is based on data provided to said server as to whether said investor or potential investor is a bank, insurance company, registered investment company, business development company, small business investment company; an employee benefit plan, within the meaning of the Employee Retirement Income Security Act, if a bank, insurance company, or registered investment adviser makes the investment decisions, or if the plan has total assets in excess of a certain minimum amount; a charitable organization, corporation, or partnership with assets exceeding a certain minimum amount; a director, executive officer, or general partner of the company selling the securities; a business in which all the equity owners are accredited investors; a natural person who has individual net worth, or joint net worth with the person's spouse, that exceeds a certain minimum amount at the time of the purchase, excluding the value of the primary residence of such person; a natural person with income exceeding a certain minimum amount in each of the two most recent years or joint income with a spouse exceeding a certain minimum amount for those years and a reasonable expectation of the same income level in the current year; or a trust with assets in excess of a certain minimum amount, not formed to acquire the securities offered, whose purchases a sophisticated person makes.

11. The method according to claim 1 wherein said receiving is a result of an investor or prospective investor completing a registration process by inputting requested information through an interface with said server.

12. A computerized system for verifying accredited investor status, comprising:
a server adapted for receiving data related to an investor or prospective investor and configured by software commands to:
determine whether said investor or prospective investor is a natural person based on said data;
determine whether said investor meets the income and/or asset value in order to qualify as an accredited investor if said investor is a natural person based on said data; and
determine whether said investor is an entity that qualifies as an accredited investor by the nature of the investor based on said data.

13. The system according to claim 12, further comprising a database for storing accredited investor status.

14. The system according to claim 12, wherein said server is further configured by software for scoring said data for determining investor status.

15. The system according to claim 14, wherein said scoring uses a weighted verification score.

16. The system according to claim 12 further comprising a communication link with said server for communication over the Internet from a client user and/or source of said data.

17. The system according to claim 16, wherein said scoring uses a weighted verification score.

18. The system according to claim 12 wherein said algorithms are configured for initiating verification inquiries through said communication link on a broad or narrow basis.

19. The system according to claim 18 where in responses to said inquiries are received by said server over said communication link for analysis by said algorithms and verification of investor accredited status.

20. The system according to claim 19 wherein said verification is stored in said database.

21. The system according to claim 1 further comprising a user interface providing access to said database by client users for viewing information in said data.

22. The system according to claim 12 wherein said determining whether said server is further configured to determine if an investor or potential investor is an entity that qualifies as an accredited investor by the nature of the investor based on data provided to said server as to whether said investor or potential investor is a bank, insurance company, registered investment company, business development company, small business investment company; an employee benefit plan, within the meaning of the Employee Retirement Income Security Act, if a bank, insurance company, or registered investment adviser makes the investment decisions, or if the plan has total assets in excess of a certain minimum amount; a charitable organization, corporation, or partnership with assets exceeding a certain minimum amount; a director, executive officer, or general partner of the company selling the securities; a business in which all the equity owners are accredited investors; a natural person who has individual net worth, or joint net worth with the person's spouse, that exceeds a certain minimum amount at the time of the purchase, excluding the value of the primary residence of such person; a natural person with income exceeding a certain minimum amount in each of the two most recent years or joint income with a spouse exceeding a certain minimum amount for those years and a reasonable expectation of the same income level in the current year; or a trust with assets in excess of a certain minimum amount, not formed to acquire the securities offered, whose purchases a sophisticated person makes.

23. The system according to claim 12 wherein said server is further configured for a registration process allowing an investor or prospective investor inputting requested information through said interface.
